(19) United States
(12) Patent Application Publication
(10) Pub. No.: US 2024/0040546 A1
(43) Pub. Date: Feb. 1, 2024

(54) PAGING CARRIER METRIC COLLECTION AND PAGING CARRIER SWITCHING

(71) Applicant: QUALCOMM Incorporated, San Diego, CA (US)

(72) Inventors: Mungal Singh DHANDA, Slough (GB); Bharat SHRESTHA, San Diego, CA (US); Umesh PHUYAL, San Diego, CA (US); Alberto RICO ALVARINO, San Diego, CA (US); Raghuveer Ramakrishna Srinivas TARIMALA, Hyderabad (IN); Raghavendra Shyam ANANDA, Hyderabad (IN)

(21) Appl. No.: 18/256,601

(22) PCT Filed: Jan. 31, 2022
(86) PCT No.: PCT/US2022/070439

§ 371 Date: Jun. 8, 2023

(30) Foreign Application Priority Data
Feb. 10, 2021 (IN) 202141005642

(51) Int. Cl. H04W 68/04

(52) U.S. Cl. CPC H04W 68/04

(57) ABSTRACT

Various aspects of the present disclosure generally relate to wireless communication. In some aspects, a user equipment (UE) may collect one or more paging metrics for a first paging carrier over a plurality of paging occasions in a collection period. The UE may communicate with a base station to switch from the first paging carrier to a second paging carrier based at least in part on the one or more paging metrics for the first paging carrier. Numerous other aspects are described.

### CROSS-REFERENCE TO RELATED APPLICATION

This Patent Application claims priority to India Patent Application No. 202141005642, filed on Feb. 10, 2021, entitled “PAGING METRIC COLLECTION AND PAGING CARRIER SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for paging carrier metric selection and paging carrier switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes collecting one or more paging metrics for a first paging carrier over a plurality of paging occasions in a collection period; and communicating with a base station to switch from the first paging carrier to a second paging carrier based at least in part on the one or more paging metrics for the first paging carrier.

In some aspects, a method of wireless communication performed by a base station includes transmitting paging information to a UE on a first paging carrier over a plurality of paging occasions in a collection period; and communicating with the UE to switch a paging carrier associated with the UE from the first paging carrier to a second paging carrier based at least in part on one or more paging metrics for the first paging carrier collected by the UE over the plurality of paging occasions in the collection period.

In some aspects, a UE for wireless communication includes a memory and one or more processors coupled to the memory, the one or more processors configured to: collect one or more paging metrics for a first paging carrier over a plurality of paging occasions in a collection period; and communicate with a base station to switch from the first paging carrier to a second paging carrier based at least in part on the one or more paging metrics for the first paging carrier.

In some aspects, a base station for wireless communication includes a memory and one or more processors coupled to the memory, the one or more processors configured to: transmit paging information to a UE on a first paging carrier over a plurality of paging occasions in a collection period; and communicate with the UE to switch a paging carrier associated with the UE from the first paging carrier to a second paging carrier based at least in part on one or more paging metrics for the first paging carrier collected by the UE over the plurality of paging occasions in the collection period.

In some aspects, a non-transitory computer-readable medium storing a set of instructions for wireless communication includes one or more instructions that, when executed by one or more processors of a UE, cause the UE to: collect one or more paging metrics for a first paging carrier over a plurality of paging occasions in a collection period; and communicate with a base station to switch from the first paging carrier to a second paging carrier based at least in part on the one or more paging metrics for the first paging carrier.

In some aspects, a non-transitory computer-readable medium storing a set of instructions for wireless communication includes one or more instructions that, when executed by one or more processors of a base station, cause the base station to: transmit paging information to a UE on a first paging carrier over a plurality of paging occasions in a collection period; and communicate with the UE to switch a paging carrier associated with the UE from the first paging carrier to a second paging carrier based at least in part on one or more paging metrics for the first paging carrier collected by the UE over the plurality of paging occasions in the collection period.

In some aspects, an apparatus for wireless communication includes means for collecting one or more paging metrics for a first paging carrier over a plurality of paging occasions in a collection period; and means for communicating with a base station to switch from the first paging carrier to a second paging carrier based at least in part on the one or more paging metrics for the first paging carrier.

In some aspects, an apparatus for wireless communication includes means for transmitting paging information to a UE on a first paging carrier over a plurality of paging occasions in a collection period; and means for communicating with the UE to switch a paging carrier associated with the UE from the first paging carrier to a second paging carrier based at least in part on one or more paging metrics for the first paging carrier collected by the UE over the plurality of paging occasions in the collection period.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a paging message, in accordance with the present disclosure.

FIGS. 4-5 are diagrams illustrating examples associated with paging carrier metric collection and paging carrier switching, in accordance with the present disclosure.

FIGS. 6-7 are diagrams illustrating example processes associated with paging carrier metric collection and paging carrier switching, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

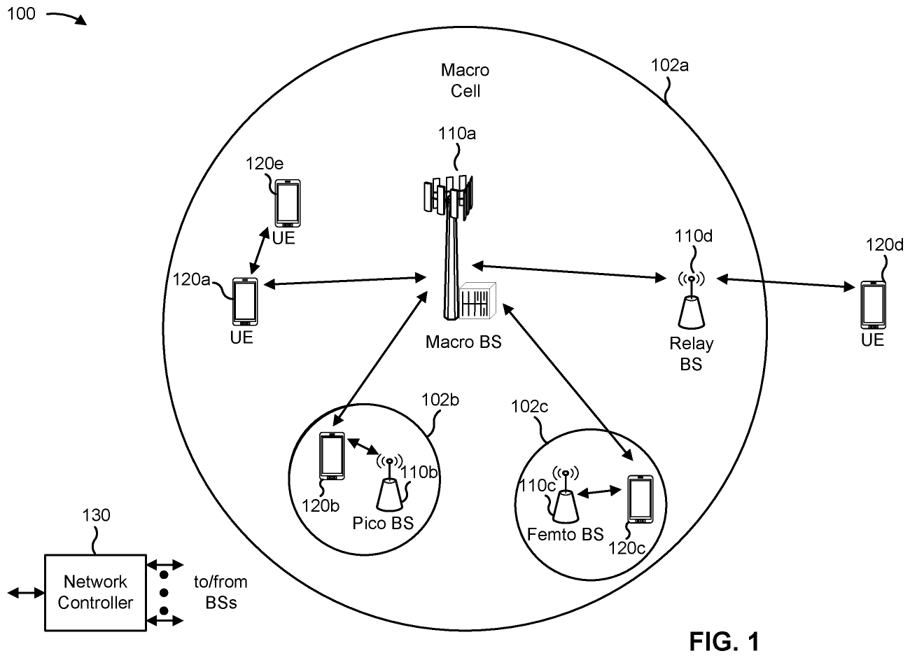

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

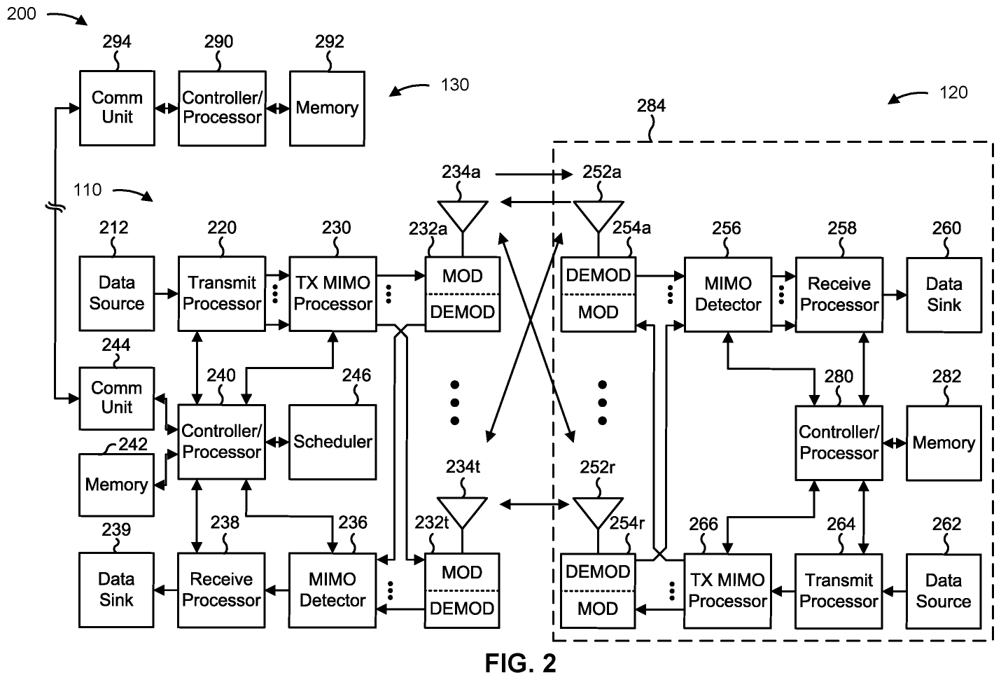

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

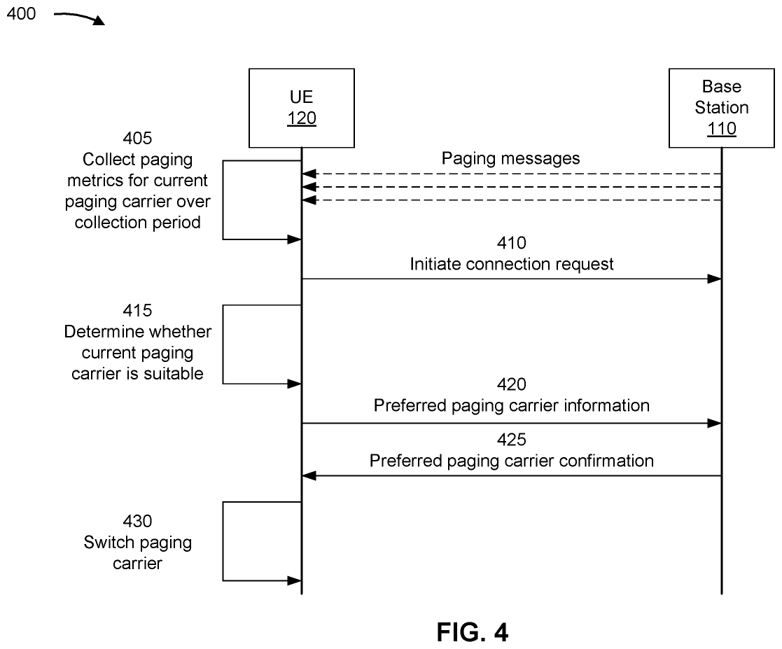

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

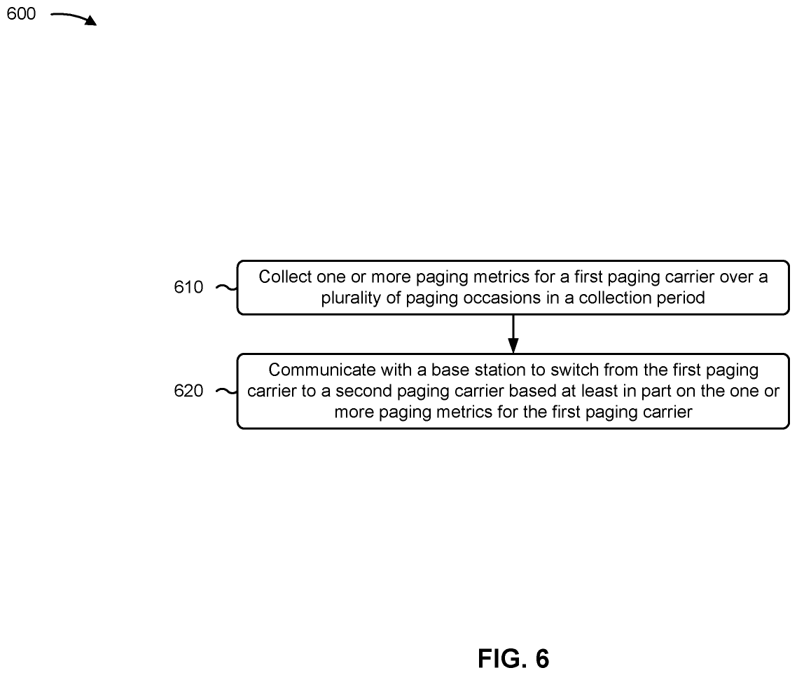

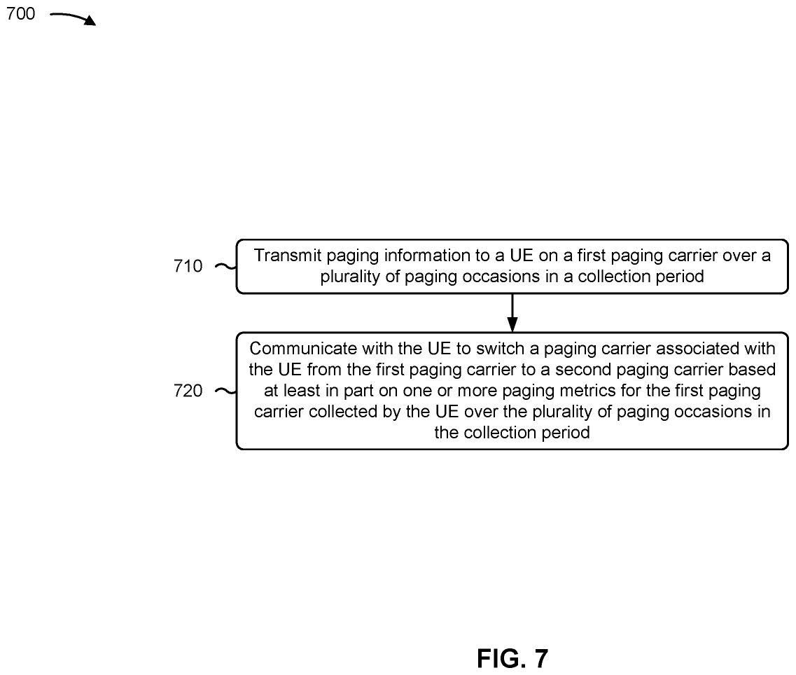

The controller/processor 240 of the base station 110, the controller/processor 280 of the UE 120, and/or any other component(s) of FIG. 2 may perform one or more techniques associated with paging carrier metric collection and paging switching, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for collecting one or more paging metrics for a first paging carrier over a plurality of paging occasions in a collection period; or means for communicating with a base station to switch from the first paging carrier to a second paging carrier based at least in part on the one or more paging metrics for the first paging carrier. The means for the UE 120 to perform operations described herein may include, for example, one or more of antenna 252, modem 254, MIMO detector 256, receive processor 258, transmit processor 264, TX MIMO processor 266, controller/processor 280, or memory 282.

In some aspects, the UE 120 includes means for communicating with the base station to switch from the first paging carrier to the second paging carrier based at least in part on a determination, from the one or more paging metrics, that the first paging carrier is not efficient for the UE.

In some aspects, the UE 120 includes means for determining that the first paging carrier is not efficient for the UE based at least in part on a determination, from the one or more paging metrics, that a maximum repetition parameter associated with the first paging carrier is excessive.

In some aspects, the UE 120 includes means for determining that the first paging carrier is not efficient for the UE based at least in part on a determination, from the one or more paging metrics, that a maximum repetition parameter associated with the first paging carrier is insufficient.

In some aspects, the UE 120 includes means for determining that the first paging carrier is not efficient for the UE based at least in part on a determination, from the one or more paging metrics, that a page decoding failure rate for the UE on the first paging carrier satisfies a threshold.

In some aspects, the UE 120 includes means for transmitting, to the base station, an indication that identifies the second paging carrier; and/or means for receiving, from the base station, a confirmation to switch to the second paging carrier.

In some aspects, the UE 120 includes means for selecting the second paging carrier from a plurality of configured paging carriers based at least in part on a comparison of a maximum repetition criterion for the UE determined from the one or more paging metrics and a maximum repetition parameter associated with the second paging carrier.

In some aspects, the UE 120 includes means for identifying a set of paging carriers that satisfy a maximum repetition criterion for the UE determined from the one or more paging metrics; and/or means for randomly selecting the second paging carrier from the set of paging carriers.

In some aspects, the UE 120 includes means for transmitting, to the base station, an indication of a preferred value for a maximum repetition parameter determined based at least in part on the one or more paging metrics; means for receiving, from the base station, a confirmation to switch to a paging carrier selected from a set of paging carriers that have the preferred value for the maximum repetition parameter; and/or means for selecting the second paging carrier from the set of paging carriers that have the preferred value for the maximum repetition parameter.

In some aspects, the UE 120 includes means for transmitting, to the base station, an indication of a preferred value for a maximum repetition parameter determined based at least in part on the one or more paging metrics; and/or means for receiving, from the base station, an indication identifying the second paging carrier as a selected paging carrier from a set of paging carriers that have the preferred value for the maximum repetition parameter.

In some aspects, the UE 120 includes means for transmitting, to the base station, the one or more paging metrics; and/or means for receiving, from the base station, paging carrier information associated with switching from the first paging carrier to the second paging carrier.

In some aspects, the UE 120 includes means for transmitting, to the base station, an indication that the one or more paging metrics are available; and/or means for receiving, from the base station, a request for the one or more paging metrics, wherein transmitting the one or more paging metrics to base station is based at least in part on receiving the request for the one or more paging metrics.

In some aspects, the UE 120 includes means for transmitting, to the base station, the indication that the one or more paging metrics are available based at least in part on a determination, from the one or more paging metrics, that the first paging carrier is not efficient for the UE.

In some aspects, the UE 120 includes means for selecting the second paging carrier from one or more paging carriers that have the maximum repetition parameter value.

In some aspects, the UE 120 includes means for selecting the second paging carrier from one or more paging carriers that have the paging cycle value.

In some aspects, the base station 110 includes means for transmitting paging information to a UE on a first paging carrier over a plurality of paging occasions in a collection period; or means for communicating with the UE to switch a paging carrier associated with the UE from the first paging carrier to a second paging carrier based at least in part on one or more paging metrics for the first paging carrier collected by the UE over the plurality of paging occasions in the collection period. The means for the base station 110 to perform operations described herein may include, for example, one or more of transmit processor 220, TX MIMO processor 230, modem 232, antenna 234, MIMO detector 236, receive processor 238, controller/processor 240, memory 242, or scheduler 246.

In some aspects, the base station 110 includes means for receiving, from the UE, an indication that identifies the second paging carrier; and/or means for transmitting, to the UE, a confirmation to switch to the second paging carrier.

In some aspects, the base station 110 includes means for receiving, from the UE, an indication of a preferred value for a maximum repetition parameter determined based at least in part on the one or more paging metrics; and/or means for transmitting, to the UE, a confirmation to switch to a paging carrier selected from a set of paging carriers that have the preferred value for the maximum repetition parameter.

In some aspects, the base station 110 includes means for receiving, from the UE, an indication of a preferred value for a maximum repetition parameter determined based at least in part on the one or more paging metrics; and/or means for transmitting, to the UE, an indication identifying the second paging carrier as a selected paging carrier from a set of paging carriers that have the preferred value for the maximum repetition parameter.

In some aspects, the base station 110 includes means for receiving, from the UE, the one or more paging metrics; or means for transmitting, to the UE, paging carrier information associated with switching from the first paging carrier to the second paging carrier.

In some aspects, the base station 110 includes means for receiving, from the UE, an indication that the one or more paging metrics are available; and/or means for transmitting, to the UE, a request for the one or more paging metrics, wherein receiving the one or more paging metrics to base station is based at least in part on transmitting the request for the one or more paging metrics.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

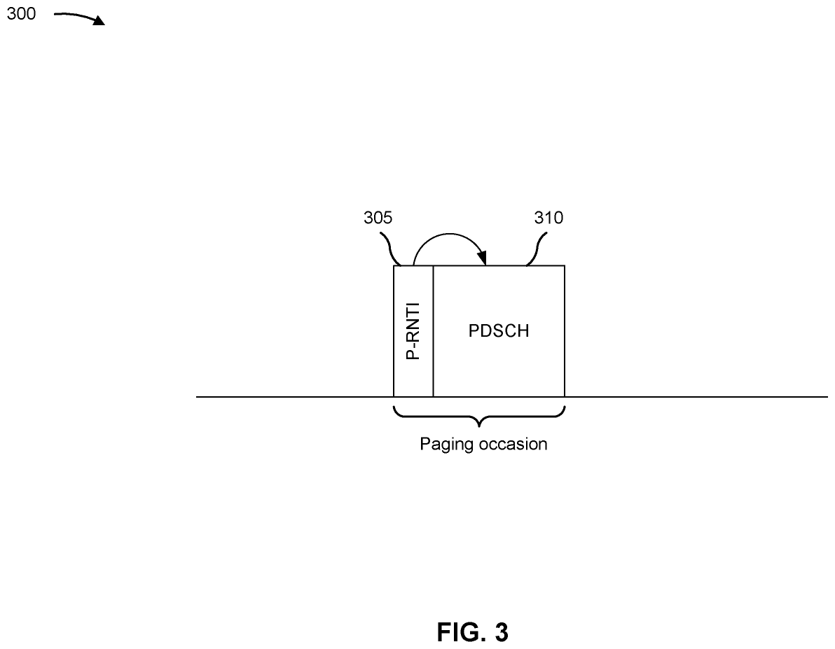

FIG. 3 is a diagram illustrating an example 300 of a paging message, in accordance with the present disclosure. When a UE is in a radio resource control (RRC) idle or inactive mode, a base station may page the UE with paging messages in predefined paging occasions to inform the UE that there is an incoming connection request, a system information update, or a short message.

As shown in FIG. 3, downlink control information (DCI) 305 with a cyclic redundancy check (CRC) scrambled by a paging radio network temporary identifier (P-RNTI) may be used to schedule a paging message 310 in a paging occasion. The paging message 310 may be physical downlink shared channel (PDSCH) communication. The DCI 305 may be included in a physical downlink control channel (PDCCH) communication, which may be referred to as a “paging PDCCH” or a “paging indication.” The DCI 305 may be group common DCI transmitted to multiple UEs.

The UE may decode the DCI 305 in the paging occasion. If the decoded DCI 305 is a P-RNTI DCI (e.g., DCI with CRC scrambled by P-RNTI), the UE may further decode the scheduled PDSCH paging message 310 and search for a UE identifier (UE-ID) associated with the UE in the decoded paging message 310 to determine whether the UE is paged. Thus, as long as one UE is paged in the paging occasion, all of the UEs that receive the DCI 305 have to decode the corresponding PDSCH paging message 310. This may be referred to as “unnecessary paging reception,” and may cause a UE to consume power and computing resources (e.g., processing resources, memory resources, communication resources, or the like) to decode paging messages that do not page the UE. The PDSCH paging message may indicate other information common to all UEs (e.g., system information modification indicator). The DCI may indicate other information common to all UEs without scheduling PDSCH (e.g., system information modification indicator, Earthquake and Tsunami Warning System (ETWS) indication, Commercial Mobile Alert System (CMAS) indication, etc.)

As indicated above, FIG. 3 is provided as an example. Other examples may differ from what is described with respect to FIG. 3.

In some cases, such as in a NB-IoT network, multiple paging carriers may be supported in a cell. In this case, each paging carrier may be configured with sufficient power level (e.g., narrowband RSRP (NRSRP)) and maximum repetitions (Rmax) in one paging occasion to allow a UE to decode paging messages transmitted on the paging carrier anywhere in the cell. A UE may use a deterministic method for selecting a paging carrier from a set of paging carriers supported in a cell. However, the deterministic method does not take into consideration the coverage level of the UE (e.g., NRSRP of the paging carrier at the UE). This may result in UEs that are in good coverage in the cell sharing the same paging carrier with UEs that are in poor coverage in the cell (e.g., UEs in extreme locations within the cell). UEs in poor coverage may require a large number of repetitions of a paging PDCCH in a paging occasion in order to decode the paging PDCCH. However, a large value of Rmax for a paging carrier may result in increased time between paging occasions for a UE, which may cause unnecessary delay in paging UEs that are in good coverage and do not require a large number of repetitions of the paging PDCCH. Furthermore, a base station may omit transmitting a page to a UE in a case in which the base station does not have paging information to send to the UE. In this case, a UE may attempt to decode paging PDCCH over all possible repetitions (e.g., Rmax subframes) of a paging occasion. Accordingly, UEs in good coverage, that do not require a larger number of repetitions, may still have to monitor a larger number of repetitions, resulting in increased consumption of power and computing resources (e.g., processing resources, memory resources, communication resources, or the like).

Some techniques and apparatuses described herein enable a UE to collect one or more paging metrics for a first paging carrier over a plurality of paging occasions in a collection period. The UE may communicate with a base station to switch from the first paging carrier to a second paging carrier based at least in part on the one or more paging metrics collected for the first paging carrier. As a result, the UE may determine that the first paging carrier has excessive repetitions (e.g., Rmax is too large) for the UE or the UE may determine that the current paging carrier does not have sufficient repetitions (e.g., Rmax is loo low) for the UE based on the collected paging metrics, and the UE and/or the base station may select a paging carrier with a more suitable value of Rmax for the UE. Thus, paging coverage may be improved for UEs that are in poor coverage in a cell and paging delay may be reduced for UEs that are in good coverage within a cell. Furthermore, unnecessary attempts to decode paging PDCCHs may be reduced for UEs in good coverage in a cell, thus resulting in reduced consumption of power and computing resources (e.g., processing resources, memory resources, communication resources, or the like).

FIG. 4 is a diagram illustrating an example 400 associated with paging carrier metric collection and paging carrier switching, in accordance with the present disclosure. As shown in FIG. 4, example 400 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an NB-IoT UE and the base station 110 and the UE 120 may be included in an NB-IoT network.

As shown in FIG. 4, and by reference number 405, the UE 120 may collect paging metrics for a current paging carrier over a collection period. A cell associated with the base station 110 may support multiple paging carriers. In some aspects, the current paging carrier may be a paging carrier selected by the UE 120 based on the UE 120 selecting a cell associated with the base station 110 during cell selection (or cell re-selection). In this case, the UE 120 may select the current paging carrier using a legacy paging carrier selection scheme. For example, the legacy paging carrier selection scheme may be a deterministic algorithm that uses a UE-ID of the UE 120 as a parameter in a modular calculation to select a paging carrier for the UE 120. In some aspects, the current paging carrier may be a paging carrier previously selected for the UE 120 based at least in part on previously collected paging metrics, as described herein.

In some aspects, the UE 120 may collect paging metrics for the paging carrier of the collection period based at least in part on a determination (e.g., based on configuration information received from the base station 110) that the cell supports coverage based paging carrier selection. As used herein, the UE 120 successfully decoding a paging occasion refers to the UE 120 successfully decoding a paging PDCCH (e.g., a narrowband PDCCH (NPDCCH)) in the paging occasion. Rmax is a maximum repetition parameter for a paging carrier that indicates a maximum number of paging PDCCH repetitions in a paging occasion for the paging carrier. When the UE 120 successfully decodes a paging occasion, the UE 120 may know how many repetitions of the paging PDCCH were needed to decode the paging occasion. However, the number of PDCCH repetitions for the UE 120 to decode a particular paging occasion may not indicate that the UE 120 will be able to decode a future paging occasion with the same number of PDCCH repetitions. Furthermore, a paging occasion in which the UE 120 is unsuccessful in decoding the paging PDCCH with Rmax repetitions may not necessarily mean that the UE 120 will be unable to decode future paging occasions. Accordingly, a determination of whether the current paging carrier is suitable or optimal for the UE 120 that is based on a single paging occasion may not be accurate.

In some aspects, the collection period may include multiple paging occasions associated with the UE 120. Accordingly, the UE 120 may collect the paging metrics for the current paging carrier over the multiple paging occasions in the collection period. In some aspects, the collection period may have a duration (e.g., 24 hours, among other examples) that is long enough for the UE 120 to collect statistically significant paging metrics, thus increasing the accuracy of a paging carrier switching determination by the UE 120. In some aspects, the collection period for the UE 120 may have a duration that corresponds to a value defined in a wireless communication standard (e.g., 3GPP standard). In some aspects, the collection period for the UE 120 may be indicated in broadcast signaling (e.g., a system information block (SIB)) broadcast by the base station 110 and received by the UE 120. In some aspects, the collection period for the UE 120 may be indicated in dedicated signaling (e.g., an RRC message, DCI, or a medium access control (MAC) message) transmitted to the UE 120 by the base station 110. In some aspects, a default duration for the collection period may correspond to a value defined in a wireless communication standard, and the duration for collection period may be changed from the default duration via broadcast signaling and/or dedicated signaling received from the base station 110.

While in an idle mode (e.g., RRC idle mode or RRC inactive mode), the UE 120 may collect the paging metrics based at least in part on paging messages transmitted, by the base station 110, on the current paging carrier in the paging occasions associated with the UE 120 during the collection period. In each paging occasion, the base station 110 may transmit up to Rmax repetitions of a paging PDCCH that schedules a PDSCH paging message. Collecting paging metrics, may include measuring, gathering, calculating, determining, tracking, and/or storing paging metrics, among other examples. In some aspects, the UE 120 may track, for each paging occasion in the collection period, whether the paging occasion was the UE 120 successfully decoded the paging occasion or failed to decode the paging occasion, a number of PDCCH (e.g., NPDCCH) repetitions for the UE 120 to decode the paging occasion, an RSRP measurement (e.g., NRSRP measurement), and/or an RSRQ measurement (e.g., narrowband RSRQ (NRSRQ) measurement), among other examples.

The number of PDCCH repetition for the UE 120 to decode the paging occasion is the number times the paging PDCCH was repeated in the paging occasion until the UE 120 was able to decode the paging PDCCH (e.g., which repetition of the paging PDCCH was decoded by the UE 120 in the paging occasion). The UE 120 may determine that the UE 120 successfully decoded a paging occasion based on any repetition of the paging PDCCH in the paging occasion was being successfully decoded by the UE 120. The UE 120 may determine that the UE 120 failed to decode a paging occasion based on the UE 120 failing to decode the PDCCH over Rmax repetitions in the paging occasion. In this case, the UE 120 may determine whether the base station 110 actually transmitted the PDCCH repetitions in the paging occasion, for example, based at least in part on determining whether a reference signal (e.g., a CRS or a narrowband reference signal (NRS) is transmitted in the paging occasion. In a case, in which the UE 120 determines that the base station 110 did not actually transmit the PDCCH repetitions, the UE 120 may not count the paging occasion as a decoding failure.

Based on the paging metrics collected on a per-paging occasion basis, as described above, the UE 120 may determine aggregate, average, minimum, and/or maximum paging metrics for the collection window. In some aspects, the paging metrics may include a total number of paging occasions successfully decoded by the UE 120 in the collection window, a total number of paging occasion decoding failures by the UE 120 in the collection window, a decoding success rate for the UE 120 in the collection window, and/or a decoding failure rate for the UE 120 in the collection window. In some aspects, the paging metrics may include a minimum number of PDCCH repetitions for the UE 120 to decode a paging occasion in the collection window, a maximum number of PDCCH repetitions for the UE 120 to decode a paging occasion in the collection window, and/or an average number of PDCCH repetitions for the UE 120 to decode a paging occasion over the multiple paging occasions in the collection period.

In some aspects, the paging metrics may include a maximum RSRP measurement over the paging occasions in the collection period, a minimum RSRP measurement over the paging occasions in the collection period, and/or an average RSRP measurement over the paging occasions in the collection period. In some aspects, the paging metrics may include a maximum RSRQ measurement over the paging occasions in the collection period, a minimum RSRQ measurement over the paging occasions in the collection period, and/or an average RSRQ measurement over the paging occasions in the collection period.

In some aspects, the paging metrics collected by the UE 120 may correspond to a paging metrics defined in a wireless communication standard (e.g., 3GPP standard). In some aspects, the paging metrics collected by the UE 120 may be indicated in broadcast signaling (e.g., an SIB) broadcast by the base station 110 and received by the UE 120. In some aspects, the paging metrics collected by the UE 120 may be indicated in dedicated signaling (e.g., an RRC message, DCI, or a MAC message) transmitted to the UE 120 by the base station 110. In some aspects, default paging metrics to be collected by the UE 120 may correspond to paging metrics defined in a wireless communication standard, and the paging metrics collected by the UE 120 may be changed from the default paging metrics via broadcast signaling and/or dedicated signaling received from the base station 110.

As further shown in FIG. 4, and by reference number 410, the UE 120 may initiate a connection request with the base station 110 to access the wireless network vis the base station 110. For example, the UE 120 may transmit, to the base station 110, an RRC connection request to initiate a connection with the base station 110 in order to switch from an idle mode (e.g., RRC idle mode or RRC inactive mode) to an RRC connected mode. In some aspects, the UE 120 may initiate the connection request to access the network specifically to perform a paging carrier switch. In some aspects, the UE 120 may perform the paging carrier switch when the UE 120 accesses the network for another reason, such as to transmit uplink data.

As further shown in FIG. 4, and by reference number 415, the UE 120 may determine whether the current paging carrier is suitable for the UE 120 based at least in part on the paging metrics collected on the current paging carrier. In some aspects, the UE 120 may determine that the current paging carrier is unsuitable or not efficient for the UE 120 based at least in part on a determination, from one or more of the paging metrics collected by the UE 120, that Rmax (e.g., the maximum repetition parameter) for the current paging carrier is excessive for the UE 120. For example, the UE 120 may determine, based on one or more paging metrics, that the UE 120 requires fewer than Rmax PDCCH repetitions. In some aspects, the UE 120 may determine whether Rmax is excessive for the UE 120 based at least in part on a determination of whether a difference between a Rmax and the average number of PDCCH repetitions for the UE 120 in the collection period satisfies a threshold. In some aspects, the UE 120 may determine whether the Rmax is excessive based at least in part on a comparison between Rmax and the maximum number of PDCCH repetitions for the UE 120 in the collection period.

In some aspects, the UE 120 may determine that the current paging carrier is unsuitable or not efficient for the UE 120 based at least in part on a determination, from one or more of the paging metrics collected by the UE 120, that Rmax (e.g., the maximum repetition parameter) for the current paging carrier is insufficient for the UE 120. For example, the UE 120 may determine, based on one or more paging metrics, that the UE 120 requires more than Rmax PDCCH repetitions. In some aspects, the UE 120 may determine whether Rmax is insufficient for the UE 120 based at least in part on a comparison of Rmax and the average number of PDCCH repetitions for the UE 120 in the collection period. In some aspects, the UE 120 may determine whether the Rmax is excessive based at least in part on a comparison between Rmax and the minimum number of PDCCH repetitions for the UE 120. In some aspects, the UE 120 may determine whether Rmax is insufficient for the UE 120 based at least in part on the decoding failure rate for the UE 120 in the collection period. For example, the UE 120 may determine whether Rmax is insufficient for the UE 120 based at least in part on a comparison between the decoding failure rate for the UE 120 in the collection period with a threshold.

In some aspects, the UE 120 may determine whether Rmax is excessive or insufficient based at least in part on a determination, from the paging metrics collected by the UE 120, of a coverage level for the UE 120. For example, the UE 120 may determine the coverage level based on the average, minimum, and/or maximum RSRP measurements, the average, minimum, and/or maximum RSRQ measurements, and/or other paging metrics described above.

As further shown in FIG. 4, and by reference number 420, the UE 120 may transmit, to the base station 110, an indication of preferred paging carrier information. For example, the UE 120 may transmit the preferred paging carrier information to the base station 110 in an RRC message or a MAC message. In some aspects, the UE 120 may transmit the preferred paging carrier information in an RRC connection request. For example, the UE 120 may include the preferred paging information in the RRC connection request in which the UE 120 initiates the RRC connection with the base station 110. In some aspects, the UE 120 may transmit the preferred carrier information in a RRC message or a MAC message after the UE 120 enters the RRC connected mode (e.g., after the UE 120 and the base station 110 complete the initial RRC connection). The UE 120 may transmit the preferred paging carrier information based at least in part on a determination that the current paging carrier is not suitable for the UE 120.

In some aspects, the UE 120 may select a preferred paging carrier (e.g., a paging carrier to switch to from the current paging carrier), and the preferred paging information may explicitly indicate the preferred paging carrier to the base station 110. For example, the preferred paging carrier information may include a paging carrier index associated with the preferred paging carrier. In this case, multiple paging carriers may be configured for the cell associated with the base station 110, and the paging carriers may be configured with different Rmax parameters. In some aspects, the UE 120 may select the preferred paging carrier based at least in part on the paging metrics collected by the UE 120. In some aspects, the UE 120 may determine a maximum repetition criterion for the UE 120 based at least in part on the paging metrics, and the UE 120 may select the preferred paging carrier based at least in part on the maximum repetition criterion. For example, the UE 120 may determine the maximum repetition criterion based at least in part on the average number of PDCCH repetitions for the UE 120, the maximum number of PDCCH repetitions for the UE 120, the minimum number of PDCCH repetitions for the UE 120, average, minimum, and/or maximum RSRP values, and/or the other paging metrics described above. The maximum repetition criterion may correspond to a preferred Rmax level for the UE 120. The UE 120 may compare the maximum repetition criterion determined for the UE 120 with the Rmax levels of the configured paging carriers for the cell, and the UE 120 may select the preferred paging carrier based on the comparison. For example, the UE 120 select a preferred paging carrier with an Rmax value that matches (or is closest too) the maximum repetition criterion.

In some cases, the UE 120 may identify a set of paging carriers based at least in part on the maximum repetition criterion. For example, the UE 120 may identify multiple paging carriers that have an Rmax value that matches the maximum repetition criterion. In some aspects, the UE 120 may randomly select the preferred paging carrier from the identified set of paging carriers. In some aspects, the UE 120 may select the preferred paging carrier from the identified set of paging carriers based at least in part on one or more other parameters of the paging carriers, such as signal power strength and/or paging occasion schedule, among other examples.

In some aspects, the preferred paging carrier information may include an indication of a selection criterion, such as the maximum repetition criterion, for selecting a preferred paging carrier for the UE 120. For example, the UE 120 may determine the maximum repetition criterion, as described above, and the UE 120 may transmit an indication of the maximum repetition criterion to the base station 110. The UE 120 may identify, from the configured paging carriers, a set of paging carriers that satisfy the selection criterion (e.g., the maximum repetition criterion). In some aspects, by transmitting the indication of the selection criterion (e.g., the maximum repetition criterion) to the base station 110, the UE 120 may indicate, to the base station 110, that the UE 120 will select the preferred paging carrier, from the set of paging carriers that satisfy the selection criterion, using a default selection scheme, such as the legacy selection scheme. In some aspects, by transmitting the indication of the selection criterion (e.g., the maximum repetition criterion) to the base station 110, the UE 120 may request that the base station 110 selects the preferred paging cater from the set of paging carriers that satisfy the selection criterion.

As further shown in FIG. 4, and by reference number 425, the base station 110 may transmit, to the UE 120, a preferred paging carrier confirmation. For example, the base station 110 may transmit the preferred paging carrier confirmation to the UE 120 in an RRC message or a MAC message. In some aspects, the base station 110 may transmit the preferred paging carrier confirmation in an RRC connection release message, which may be received by the UE 120 prior to returning to the idle mode and resuming monitoring paging occasions.

In some aspects, the base station 110 may transmit the preferred paging cater confirmation to the UE 120 based at least in part on receiving, from the UE 120, preferred paging carrier information that includes an explicit indication (e.g., paging carrier index) of the preferred paging carrier selected by the UE 120. In this case, the preferred paging carrier confirmation may include an indication that confirms the preferred paging carrier selected by the UE 120.

In some aspects, the base station 110 may transmit the preferred paging cater confirmation to the UE 120 based at least in part on receiving, from the UE 120, preferred paging carrier information that includes a selection criterion for the UE 120, such as the maximum repetition criterion. In some aspects, the base station 110 may transmit, based at least in part on receiving preferred paging carrier information that includes the selection criterion, a preferred paging carrier confirmation that includes an indication that confirms that the UE 120 will select, the preferred paging carrier from a set of paging carriers that satisfy the selection criterion. In this case, the UE 120 may receive the preferred paging carrier confirmation and select the preferred paging carrier from the set of paging carriers that satisfy the selection criterion using a default selection scheme, such as the legacy selection scheme.

In some aspects, based at least in part on receiving preferred paging carrier information that includes the selection criterion, the base station 110 may select the preferred paging carrier for the UE 120 from a set of paging carriers that satisfy the selection criterion, and the preferred paging carrier confirmation may include an indication of the preferred paging carrier (e.g., the paging carrier index associated with the preferred paging carrier). For example, the base station 110 may select the preferred paging cater for the UE 120, from the set of paging carriers that satisfy the selection criterion, based at least in part on a current distribution of the configured paging carriers to UEs in the cell.

As further shown in FIG. 4, and by reference number 430, the UE 120 may switch paging carriers based at least in part on receiving the preferred paging carrier confirmation from the base station 110. The UE 120 may determine, for example when switching to an idle mode (e.g., RRC idle mode or RRC inactive mode), whether the confirmation of the preferred paging carrier has been received from the base station 110. Based at least in part on receiving preferred paging carrier information that confirms the preferred paging carrier, the UE 120 may switch from the current paging cater to the preferred paging carrier upon return to the idle mode. In this case, the UE 120 may monitor the preferred paging carrier in paging occasions associated with the UE 120 on the preferred paging carrier. The base station 110 may send paging messages to the UE 120 on the preferred paging carrier, with a maximum number of PDCCH repetitions in each paging occasion corresponding to the Rmax value associated with the preferred paging carrier. In a case in which the preferred paging carrier confirmation is not received by the UE 120 prior to the UE 120 switching to an idle mode, the UE 120 may switch to the idle mode and continue monitoring the same paging carrier that the UE 120 was monitoring prior to accessing the cell.

As described above in connection with FIG. 4, the UE 120 may collect one or more paging metrics for a first paging carrier over a plurality of paging occasions in a collection period. The UE 120 may determine whether the first paging carrier is suitable for the UE 120 based at least in part on the collected paging metrics. The UE 120 may transmit, to the base station 110, an indication of preferred paging carrier information associated with a second paging carrier selected based at least on part on the collected paging metrics. The UE 120 may receive, from the base station 110, a preferred paging carrier confirmation, and the UE 120 may switch from the first paging carrier to the second paging carrier based at least in part on receiving the preferred paging carrier confirmation. As a result, paging coverage may be improved for UEs that are in poor coverage in a cell and paging delay may be reduced for UEs that are in good coverage within a cell. Furthermore, unnecessary attempts to decode paging PDCCHs may be reduced for UEs in good coverage in a cell, thus resulting in reduced consumption of power and computing resources (e.g., processing resources, memory resources, communication resources, or the like).

As indicated above, FIG. 4 is provided as an example. Other examples may differ from what is described with respect to FIG. 4.

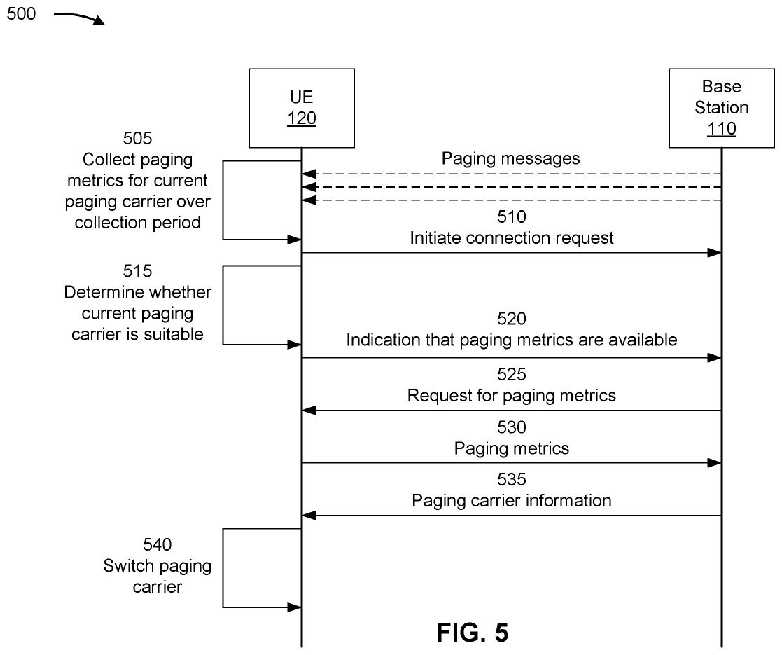

FIG. 5 is a diagram illustrating an example 500 associated with paging carrier metric collection and paging carrier switching, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an NB-IoT UE and the base station 110 and the UE 120 may be included in an NB-IoT network.

As shown in FIG. 5, and by reference number 505, the UE 120 may collect paging metrics for a current paging carrier over a collection period. The base station 110 may transmit paging messages on the current paging carrier in multiple paging occasions associated with the UE 120 in the collection period, and the UE 120 may collect the paging metrics for the current paging carrier over the multiple paging occasions in the collection period, as described above in connection with FIG. 4.

As further shown in FIG. 5, and by reference number 510, the UE 120 may initiate a connection request with the base station 110 to access the wireless network vis the base station 110. For example, the UE 120 may transmit, to the base station 110, an RRC connection request to initiate a connection with the base station 110 in order to switch from an idle mode (e.g., RRC idle mode or RRC inactive mode) to an RRC connected mode. In some aspects, the UE 120 may initiate the connection request to access the network specifically to perform a paging carrier switch. In some aspects, the UE 120 may perform the paging carrier switch when the UE 120 accesses the network for another reason, such as to transmit uplink data.

As further shown in FIG. 5, and by reference number 515, the UE 120 may determine whether the current paging carrier is suitable for the UE 120 based at least in part on the paging metrics collected on the current paging carrier. For example, the UE 120 may determine, based at least in part on the paging metrics, whether Rmax for the current paging carrier is excessive or insufficient, as described above in connection with FIG. 4.

As further shown in FIG. 5, and by reference number 520, the UE 120 may transmit, to the base station 110, an indication that the paging metrics for the current paging carrier are available on the UE 120. For example, the UE 120 may transmit the indication that the paging metrics are available to the base station 110 in an RRC message or a MAC message. In some aspects, the UE 120 may transmit the indication that the paging metrics are available in an RRC connection request. For example, the UE 120 may include the indication that the paging metrics are available in the RRC connection request in which the UE 120 initiates the RRC connection with the base station 110. In some aspects, the UE 120 may transmit the indication the paging metrics are available in an RRC message or a MAC message after the UE 120 enters the RRC connected mode (e.g., after the UE 120 and the base station 110 complete the initial RRC connection).

In some aspects, the UE 120 may transmit the indication that the paging metrics are available based at least in part on a determination that the current paging carrier is not suitable for the UE 120. In some aspects, the UE 120 may transmit the indication that the paging metrics are available based on accessing the network (e.g., initiating the connection request) after the collection period has been completed, independent of a determination, by the UE 120, of whether the current paging carrier is unsuitable or not efficient for the UE 120.

As further shown in FIG. 5, and by reference number 525, the base station 110 may transmit, to the UE 120, a request for the paging metrics collected by the UE 120. For example, the base station 110 may transmit the request for the paging metrics to the UE 120 in an RRC message or a MAC message. In some aspects, the base station 110 may transmit the request for the paging metrics in an RRC connection setup message. For example, the base station 110 may include the request for the paging metrics in an RRC connection setup message based at least in part on receiving, from the UE 120, an RRC connection request that includes the indication that the paging metrics are available. In some aspects, the request for the paging metrics may include a request for all of a subset of the paging metrics collected by the UE 120.

As further shown in FIG. 5, and by reference number 530, the UE 120 may transmit, to the base station 110, the paging metrics collected by the UE 120. For example, the UE 120 may transmit the paging metrics to the UE 120 in an RRC message, a MAC message, or another uplink transmission. In some aspects, the UE 120 may transmit the paging metrics in an RRC setup complete message. For example, the UE 120 may transmit the paging metrics in an RRC setup complete message based at least in part on receiving, from the base station 110, the request for the paging metrics in an RRC connection setup message. In some aspects, the UE 120 may transmit the paging metrics to the base station 110 based at least in part on receiving the request for the paging metrics from the base station 110. In this case, the UE 120 may transmit, to the base station 110, all of the paging metrics collected in the collection period or a subset of the paging metrics specified in the request for the paging metrics.

In some aspects, the UE 120 may transmit, to the base station 110, the collected paging metrics without first receiving a request for the paging metrics from the base station 110. For example, in some aspects, the UE 120 may transmit the paging metrics to the base station 110 based at least in part on a determination, by the UE 120, that the current paging carrier is unsuitable or not efficient for the UE 120. In some aspects, the UE 120 may transmit the paging metrics to the base station 110 based at least in part on accessing the network (e.g., initiating the connection request), independent of a determination, by the UE 120, of whether the current paging carrier is suitable.

As further shown in FIG. 5, and by reference number 535, the base station 110 may transmit, to the UE 120, paging carrier information associated with a selected paging carrier. For example, the base station 110 may transmit the paging carrier information to the UE 120 in an RRC message, a MAC message, or another downlink communication. In some aspects, the base station 110 may transmit the paging carrier information to the UE 120 in an RRC connection release message.

In some aspects, the base station 110 may select a paging carrier for the UE 120 to switch to based at least in part on the paging metrics received from the UE 120, and the base station 110 may transmit paging carrier information associated with the selected paging carrier. In some aspects, the paging carrier information may explicitly indicate the selected paging carrier to the UE 120. For example, the paging carrier information may include a paging carrier index associated with the selected paging carrier. In this case, multiple paging carriers may be configured for the cell associated with the base station 110, and the paging carriers may be configured with different Rmax parameters. In some aspects, the base station 110 determine a maximum repetition criterion for the UE 120 based at least in part on the paging metrics, and the base station 110 may select the paging carrier for the UE 120 based at least in part on the maximum repetition criterion for the UE 120. For example, the base station 110 may determine the maximum repetition criterion for the UE 120, similar to as described above for the UE 120 in connection FIG. 4.

In some cases, the base station 110 may identify a set of paging carriers that satisfy the maximum repetition criterion determined for the UE 120. In some aspects, the base station 110 may select the preferred paging carrier from the identified set of paging carriers based at least in part on a current distribution of the paging carriers to UEs in the cell and/or one or more other parameters of the paging carriers, such as signal power strength and/or paging occasion schedule, among other examples.

In some aspects, the base station 110 may identify a set of paging carriers from which a paging carrier is to be selected by the UE 120. For example, the paging carrier information may include a paging carrier index that identifies a set of paging carriers, and the UE 120 may select a paging carrier to switch to from the set of paging carriers identified by the paging carrier index included in the paging carrier information. In this case, different sets of paging carriers may be configured and associated with different paging carrier indexes. In some aspects, the set of paging carriers identified by the paging carrier index may be a set of paging carriers that satisfy the maximum repetition criterion determined for the UE 120.

In some aspects, the base station 110 may include, in the paging carrier information, an indication of selection criteria for the UE 120 to use to select the paging carrier from multiple paging carriers configured for the cell. For example, the selection criteria may include an Rmax value and/or a paging cycle value. In this case, based at least in part on receiving the selection criteria from the base station 110, the UE 120 may identify, from the configured paging carriers for the cell, a set of paging carriers that satisfy the selection criteria. The UE 120 may select a paging carrier, from the identified set of paging carriers that satisfy the selection criteria, using a default selection scheme, such as the legacy selection scheme.

In some aspects, the base station 110 may explicitly signal, in the paging carrier information, a downlink carrier frequency (e.g., paging carrier frequency) associated with a selected paging carrier for the UE 120. The base station 110 may also include in the paging information one or more other parameters associated with the selected paging carrier. For example, the paging information may include an indication of the downlink carrier frequency for the selected paging carrier, an indication of a power offset for the selected paging carrier, and/or information that identified one or more paging occasions, in a frame, that are associated with the UE 120 on the selected paging carrier. In this case, for any remaining parameter of the selected paging carrier that is not explicitly signaled by the base station 110 in the paging carrier information, the UE 120 may apply a corresponding value for that parameter in an anchor carrier in the cell. In this way, the base station 110 may provide an indication of a selected paging carrier to which the UE 120 may switch, even if the UE 120 is not aware of configured paging carriers for the cell.

In some aspects, the base station 110 may determine whether the current paging carrier is suitable for the UE 120 prior to selecting the paging carrier to which the UE 120 should switch. For example, in some aspects, the UE 120 may transmit the paging metrics to the base station 110 independent of a determination, by the UE 120, of whether the current paging carrier is suitable for the UE 120. In this case, the base station 110 may determine whether the current paging carrier is suitable for the UE 120 based at least in part on the paging metrics received from the UE 120, and the base station 110 may select the paging carrier for the UE 120 to switch to based at least in part on a determination that the current paging carrier is not suitable for the UE 120.

As further shown in FIG. 5, and by reference number 540, the UE 120 may switch paging carriers based at least in part on receiving the paging carrier information from the base station 110. The UE 120 may determine, for example when switching to an idle mode (e.g., RRC idle mode or RRC inactive mode), whether the paging carrier information has been received from the base station 110. Based at least in part on receiving the paging carrier information that indicates the selected paging carrier to which the UE 120 may switch, the UE 120 may switch from the current paging carrier to the selected paging carrier and return to the idle mode. In this case, the UE 120 may monitor the selected paging carrier in paging occasions associated with the UE 120 on the selected paging carrier. The base station 110 may send paging messages to the UE 120 on the selected paging carrier, with a maximum number of PDCCH repetitions in each paging occasion corresponding to the Rmax value associated with the selected paging carrier. In a case in which the paging carrier information is not received by the UE 120 prior to the UE 120 switching to an idle mode, the UE 120 may switch to the idle mode and continue monitoring the same paging carrier that the UE 120 was monitoring before it initiated RRC connection.

As described above in connection with FIG. 5, the UE 120 may collect one or more paging metrics for a first paging carrier over a plurality of paging occasions in a collection period. The UE 120 may determine whether the first paging carrier is suitable for the UE 120 based at least in part on the collected paging metrics. The UE 120 may transmit the collected paging metrics to the base station 110. The base station 110 may select a second paging carrier for the UE 120 based at least in part on the paging metrics, and the base station 110 may transmit, to the UE 120, paging carrier information associated with the second paging carrier. The UE 120 may switch from the first paging carrier to the second paging carrier based at least in part on receiving the preferred paging carrier confirmation. As a result, paging coverage may be improved for UEs that are in poor coverage in a cell and paging delay may be reduced for UEs that are in good coverage within a cell. Furthermore, unnecessary attempts to decode paging PDCCHs may be reduced for UEs in good coverage in a cell, thus resulting in reduced consumption of power and computing resources (e.g., processing resources, memory resources, communication resources, or the like).

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with paging carrier metric collection and paging carrier switching.

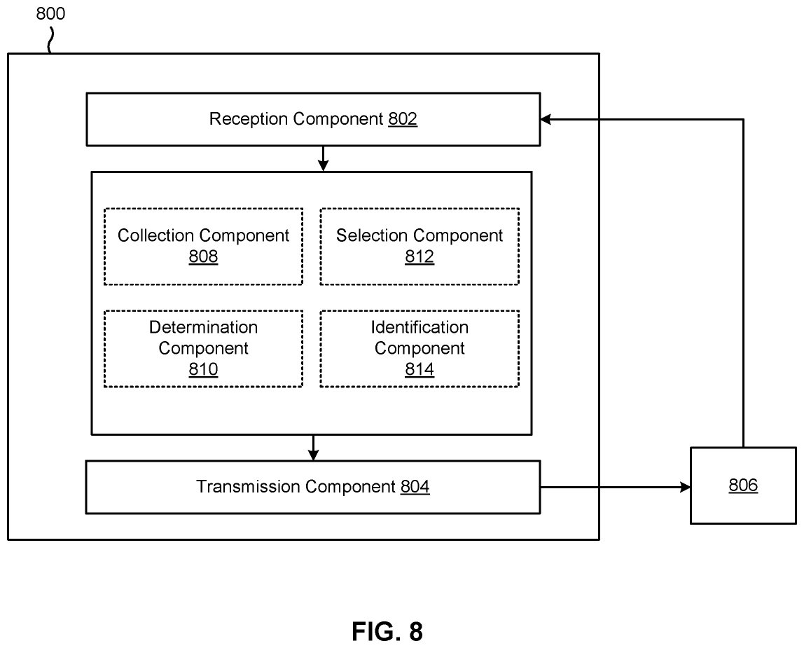

As shown in FIG. 6, in some aspects, process 600 may include collecting one or more paging metrics for a first paging carrier over a plurality of paging occasions in a collection period (block 610). For example, the UE (e.g., using collection component 808, depicted in FIG. 8) may collect one or more paging metrics for a first paging carrier over a plurality of paging occasions in a collection period, as described above.

As further shown in FIG. 6, in some aspects, process 600 may include communicating with a base station to switch from the first paging carrier to a second paging carrier based at least in part on the one or more paging metrics for the first paging carrier (block 620). For example, the UE (e.g., using reception component 802 and/or transmission component 804, depicted in FIG. 8) may communicate with a base station to switch from the first paging carrier to a second paging carrier based at least in part on the one or more paging metrics for the first paging carrier, as described above.

Process 600 may include additional aspects, such as any single aspect or any combination of aspects described below and/or in connection with one or more other processes described elsewhere herein.

In a first aspect, the one or more paging metrics include a total number of paging occasions successfully decoded by the UE in the collection period.

In a second aspect, alone or in combination with the first aspect, the one or more paging metrics include a total number of paging occasion decode failures by the UE in the collection period.

In a third aspect, alone or in combination with one or more of the first and second aspects, the one or more paging metrics include, for each paging occasion of the plurality of paging occasions, a respective number of PDCCH repetitions for the UE to decode the paging occasion.

In a fourth aspect, alone or in combination with one or more of the first through third aspects, the one or more paging metrics include a minimum number of PDCCH repetitions for the UE to decode a paging occasion over the plurality of paging occasions in the collection period.

In a fifth aspect, alone or in combination with one or more of the first through fourth aspects, the one or more paging metrics include a maximum number of PDCCH repetitions for the UE to decode a paging occasion over the plurality of paging occasions in the collection period.

In a sixth aspect, alone or in combination with one or more of the first through fifth aspects, the one or more paging metrics include an average number of PDCCH repetitions for the UE to decode a paging occasion over the plurality of paging occasions in the collection period.

In a seventh aspect, alone or in combination with one or more of the first through sixth aspects, the one or more paging metrics include a respective reference signal receive power measurement for the UE for each paging occasion of the plurality of paging occasions in the collection period.

In an eighth aspect, alone or in combination with one or more of the first through seventh aspects, the one or more paging metrics include a maximum reference signal receive power measurement for the UE over the plurality of paging occasions in the collection period.

In a ninth aspect, alone or in combination with one or more of the first through eighth aspects, the one or more paging metrics include a minimum reference signal receive power measurement for the UE over the plurality of paging occasions in the collection period.

In a tenth aspect, alone or in combination with one or more of the first through ninth aspects, the one or more paging metrics include an average reference signal receive power measurement for the UE over the plurality of paging occasions in the collection period.

In an eleventh aspect, alone or in combination with one or more of the first through tenth aspects, communicating with the base station to switch from the first paging carrier to the second paging carrier comprises communicating with the base station to switch from the first paging carrier to the second paging carrier based at least in part on a determination, from the one or more paging metrics, that the first paging carrier is not efficient for the UE.

In a twelfth aspect, alone or in combination with one or more of the first through eleventh aspects, process 600 includes determining that the first paging carrier is not efficient for the UE based at least in part on a determination, from the one or more paging metrics, that a maximum repetition parameter associated with the first paging carrier is excessive.

In a thirteenth aspect, alone or in combination with one or more of the first through twelfth aspects, process 600 includes determining that the first paging carrier is not efficient for the UE based at least in part on a determination, from the one or more paging metrics, that a maximum repetition parameter associated with the first paging carrier is insufficient.

In a fourteenth aspect, alone or in combination with one or more of the first through thirteenth aspects, process 600 includes determining that the first paging carrier is not efficient for the UE based at least in part on a determination, from the one or more paging metrics, that a page decoding failure rate for the UE on the first paging carrier satisfies a threshold.

In a fifteenth aspect, alone or in combination with one or more of the first through fourteenth aspects, communicating with the base station to switch from the first paging carrier to a second paging carrier comprises transmitting, to the base station, an indication that identifies the second paging carrier, and receiving, from the base station, a confirmation to switch to the second paging carrier.

In a sixteenth aspect, alone or in combination with one or more of the first through fifteenth aspects, process 600 includes selecting the second paging carrier from a plurality of configured paging carriers based at least in part on a comparison of a maximum repetition criterion for the UE determined from the one or more paging metrics and a maximum repetition parameter associated with the second paging carrier.

In a seventeenth aspect, alone or in combination with one or more of the first through sixteenth aspects, process 600 includes identifying a set of paging carriers that satisfy a maximum repetition criterion for the UE determined from the one or more paging metrics, and randomly selecting the second paging carrier from the set of paging carriers.

In an eighteenth aspect, alone or in combination with one or more of the first through seventeenth aspects, communicating with the base station to switch from the first paging carrier to a second paging carrier comprises transmitting, to the base station, an indication of a preferred value for a maximum repetition parameter determined based at least in part on the one or more paging metrics, receiving, from the base station, a confirmation to switch to a paging carrier selected from a set of paging carriers that have the preferred value for the maximum repetition parameter, and selecting the second paging carrier from the set of paging carriers that have the preferred value for the maximum repetition parameter.

In a nineteenth aspect, alone or in combination with one or more of the first through eighteenth aspects, communicating with the base station to switch from the first paging carrier to a second paging carrier comprises transmitting, to the base station, an indication of a preferred value for a maximum repetition parameter determined based at least in part on the one or more paging metrics, and receiving, from the base station, an indication identifying the second paging carrier as a selected paging carrier from a set of paging carriers that have the preferred value for the maximum repetition parameter.

In a twentieth aspect, alone or in combination with one or more of the first through nineteenth aspects, communicating with the base station to switch from the first paging carrier to a second paging carrier comprises transmitting, to the base station, the one or more paging metrics, and receiving, from the base station, paging carrier information associated with switching from the first paging carrier to the second paging carrier.

In a twenty-first aspect, alone or in combination with one or more of the first through twentieth aspects, communicating with the base station to switch from the first paging carrier to a second paging carrier further comprises transmitting, to the base station, an indication that the one or more paging metrics are available, and receiving, from the base station, a request for the one or more paging metrics, and transmitting the one or more paging metrics to base station is based at least in part on receiving the request for the one or more paging metrics.

In a twenty-second aspect, alone or in combination with one or more of the first through twenty-first aspects, transmitting the indication that the one or more paging metrics are available comprises transmitting, to the base station, the indication that the one or more paging metrics are available based at least in part on a determination, from the one or more paging metrics, that the first paging carrier is not efficient for the UE.

In a twenty-third aspect, alone or in combination with one or more of the first through twenty-second aspects, the paging carrier information includes a paging carrier index that identifies the second paging carrier.

In a twenty-fourth aspect, alone or in combination with one or more of the first through twenty-third aspects, the paging carrier information indicates a maximum repetition parameter value, and process 600 includes selecting the second paging carrier from one or more paging carriers that have the maximum repetition parameter value.

In a twenty-fifth aspect, alone or in combination with one or more of the first through twenty-fourth aspects, the paging carrier information indicates a paging cycle value, and process 600 includes selecting the second paging carrier from one or more paging carriers that have the paging cycle value.

In a twenty-sixth aspect, alone or in combination with one or more of the first through twenty-fifth aspects, the paging carrier information indicates a downlink carrier frequency for the second paging carrier.

In a twenty-seventh aspect, alone or in combination with one or more of the first through twenty-sixth aspects, the paging carrier information indicates a power offset for the second paging carrier.

In a twenty-eighth aspect, alone or in combination with one or more of the first through twenty-seventh aspects, the paging carrier information identifies one or more paging occasions, in a frame, that are associated with the second paging carrier.

In a twenty-ninth aspect, alone or in combination with one or more of the first through twenty-eighth aspects, the paging carrier information includes a paging carrier index that identifies a set of paging carriers, and process 600 includes selecting the second paging carrier from the set of paging carriers identified by the paging carrier index.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with paging carrier metric collection and paging carrier switching.

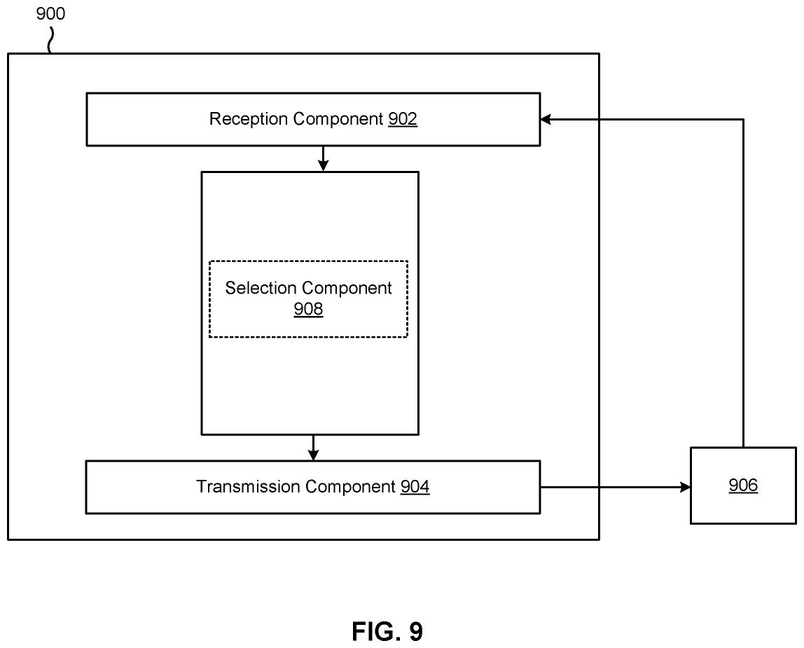

As shown in FIG. 7, in some aspects, process 700 may include transmitting paging information to a UE on a first paging carrier over a plurality of paging occasions in a collection period (block 710). For example, the base station (e.g., using transmission component 904, depicted in FIG. 9) may transmit paging information to a UE on a first paging carrier over a plurality of paging occasions in a collection period, as described above.

As further shown in FIG. 7, in some aspects, process 700 may include communicating with the UE to switch a paging carrier associated with the UE from the first paging carrier to a second paging carrier based at least in part on one or more paging metrics for the first paging carrier collected by the UE over the plurality of paging occasions in the collection period (block 720). For example, the base station (e.g., using reception component 902 and/or transmission component 904, depicted in FIG. 9) may communicate with the UE to switch a paging carrier associated with the UE from the first paging carrier to a second paging carrier based at least in part on one or more paging metrics for the first paging carrier collected by the UE over the plurality of paging occasions in the collection period, as described above.

Process 700 may include additional aspects, such as any single aspect or any combination of aspects described below and/or in connection with one or more other processes described elsewhere herein.

In a first aspect, the one or more paging metrics include a total number of paging occasions successfully decoded by the UE in the collection period.

In a second aspect, alone or in combination with the first aspect, the one or more paging metrics include a total number of paging occasion decode failures by the UE in the collection period.

In a third aspect, alone or in combination with one or more of the first and second aspects, the one or more paging metrics include, for each paging occasion of the plurality of paging occasions, a respective number of PDCCH repetitions for the UE to decode the paging occasion.

In a fourth aspect, alone or in combination with one or more of the first through third aspects, the one or more paging metrics include a minimum number of PDCCH repetitions for the UE to decode a paging occasion over the plurality of paging occasions in the collection period.

In a fifth aspect, alone or in combination with one or more of the first through fourth aspects, the one or more paging metrics include a maximum number of PDCCH repetitions for the UE to decode a paging occasion over the plurality of paging occasions in the collection period.

In a sixth aspect, alone or in combination with one or more of the first through fifth aspects, the one or more paging metrics include an average number of PDCCH repetitions for the UE to decode a paging occasion over the plurality of paging occasions in the collection period.

In a seventh aspect, alone or in combination with one or more of the first through sixth aspects, the one or more paging metrics include a respective reference signal receive power measurement for the UE for each paging occasion of the plurality of paging occasions in the collection period.

In an eighth aspect, alone or in combination with one or more of the first through seventh aspects, the one or more paging metrics include a maximum reference signal receive power measurement for the UE over the plurality of paging occasions in the collection period.

In a ninth aspect, alone or in combination with one or more of the first through eighth aspects, the one or more paging metrics include a minimum reference signal receive power measurement for the UE over the plurality of paging occasions in the collection period.

In a tenth aspect, alone or in combination with one or more of the first through ninth aspects, the one or more paging metrics include an average reference signal receive power measurement for the UE over the plurality of paging occasions in the collection period.

In an eleventh aspect, alone or in combination with one or more of the first through tenth aspects, communicating with the UE to switch a paging carrier associated with the UE from the first paging carrier to a second paging carrier comprises receiving, from the UE, an indication that identifies the second paging carrier, and transmitting, to the UE, a confirmation to switch to the second paging carrier.

In a twelfth aspect, alone or in combination with one or more of the first through eleventh aspects, communicating with the UE to switch a paging carrier associated with the UE from the first paging carrier to a second paging carrier comprises receiving, from the UE, an indication of a preferred value for a maximum repetition parameter determined based at least in part on the one or more paging metrics, transmitting, to the UE, a confirmation to switch to a paging carrier selected from a set of paging carriers that have the preferred value for the maximum repetition parameter.

In a thirteenth aspect, alone or in combination with one or more of the first through twelfth aspects, communicating with the UE to switch a paging carrier associated with the UE from the first paging carrier to a second paging carrier comprises receiving, from the UE, an indication of a preferred value for a maximum repetition parameter determined based at least in part on the one or more paging metrics, and transmitting, to the UE, an indication identifying the second paging carrier as a selected paging carrier from a set of paging carriers that have the preferred value for the maximum repetition parameter.

In a fourteenth aspect, alone or in combination with one or more of the first through thirteenth aspects, communicating with the UE to switch a paging carrier associated with the UE from the first paging carrier to a second paging carrier comprises receiving, from the UE, the one or more paging metrics, and transmitting, to the UE, paging carrier information associated with switching from the first paging carrier to the second paging carrier.

In a fifteenth aspect, alone or in combination with one or more of the first through fourteenth aspects, communicating with the UE to switch a paging carrier associated with the UE from the first paging carrier to a second paging carrier further comprises receiving, from the UE, an indication that the one or more paging metrics are available, and transmitting, to the UE, a request for the one or more paging metrics, and receiving the one or more paging metrics to base station is based at least in part on transmitting the request for the one or more paging metrics.

In a sixteenth aspect, alone or in combination with one or more of the first through fifteenth aspects, the paging carrier information includes a paging carrier index that identifies the second paging carrier.

In a seventeenth aspect, alone or in combination with one or more of the first through sixteenth aspects, the paging carrier information indicates a maximum repetition parameter value associated with the second paging carrier.

In an eighteenth aspect, alone or in combination with one or more of the first through seventeenth aspects, the paging carrier information indicates a paging cycle value associated with the second paging carrier.

In a nineteenth aspect, alone or in combination with one or more of the first through eighteenth aspects, the paging carrier information indicates a downlink carrier frequency for the second paging carrier.

In a twentieth aspect, alone or in combination with one or more of the first through nineteenth aspects, the paging carrier information indicates a power offset for the second paging carrier.

In a twenty-first aspect, alone or in combination with one or more of the first through twentieth aspects, the paging carrier information identifies one or more paging occasions, in a frame, that are associated with the second paging carrier.

In a twenty-second aspect, alone or in combination with one or more of the first through twenty-first aspects, the paging carrier information includes a paging carrier index that identifies a set of paging carriers from which the second paging carrier is to be selected by the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include one or more of a collection component 808, a determination component 810, a selection component 812, or an identification component 814, among other examples.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The collection component 808 may collect one or more paging metrics for a first paging carrier over a plurality of paging occasions in a collection period. The reception component 802 and/or the transmission component 804 may communicate with a base station to switch from the first paging carrier to a second paging carrier based at least in part on the one or more paging metrics for the first paging carrier.

The determination component 810 may determine that the first paging carrier is not efficient for the UE based at least in part on a determination, from the one or more paging metrics, that a maximum repetition parameter associated with the first paging carrier is excessive.

The determination component 810 may determine that the first paging carrier is not efficient for the UE based at least in part on a determination, from the one or more paging metrics, that a maximum repetition parameter associated with the first paging carrier is insufficient.

The determination component 810 may determine that the first paging carrier is not efficient for the UE based at least in part on a determination, from the one or more paging metrics, that a page decoding failure rate for the UE on the first paging carrier satisfies a threshold.

The selection component 812 may select the second paging carrier from a plurality of configured paging carriers based at least in part on a comparison of a maximum repetition criterion for the UE determined from the one or more paging metrics and a maximum repetition parameter associated with the second paging carrier.

The identification component 814 may identify a set of paging carriers that satisfy a maximum repetition criterion for the UE determined from the one or more paging metrics.

The selection component 812 may randomly select the second paging carrier from the set of paging carriers.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a selection component 908, among other examples.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be co-located with the reception component 902 in a transceiver.

The transmission component 904 may transmit paging information to a UE on a first paging carrier over a plurality of paging occasions in a collection period. The reception component 902 and/or transmission component 904 may communicate with the UE to switch a paging carrier associated with the UE from the first paging carrier to a second paging carrier based at least in part on one or more paging metrics for the first paging carrier collected by the UE over the plurality of paging occasions in the collection period. In some aspects, the selection component 908 may select the second paging carrier for the UE based at least in part on the one or more paging metrics.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: collecting one or more paging metrics for a first paging carrier over a plurality of paging occasions in a collection period; and communicating with a base station to switch from the first paging carrier to a second paging carrier based at least in part on the one or more paging metrics for the first paging carrier.

Aspect 2: The method of Aspect 1, wherein the one or more paging metrics include a total number of paging occasions successfully decoded by the UE in the collection period.

Aspect 3: The method of any of Aspects 1-2, wherein the one or more paging metrics include a total number of paging occasion decode failures by the UE in the collection period.

Aspect 4: The method of any of Aspects 1-3, wherein the one or more paging metrics include, for each paging occasion of the plurality of paging occasions, a respective number of physical downlink control channel (PDCCH) repetitions for the UE to decode the paging occasion.

Aspect 5: The method of any of Aspects 1-4, wherein the one or more paging metrics include a minimum number of physical downlink control channel (PDCCH) repetitions for the UE to decode a paging occasion over the plurality of paging occasions in the collection period.

Aspect 6: The method of any of Aspects 1-5, wherein the one or more paging metrics include a maximum number of physical downlink control channel (PDCCH) repetitions for the UE to decode a paging occasion over the plurality of paging occasions in the collection period.

Aspect 7: The method of any of Aspects 1-6, wherein the one or more paging metrics include an average number of physical downlink control channel (PDCCH) repetitions for the UE to decode a paging occasion over the plurality of paging occasions in the collection period.

Aspect 8: The method of any of Aspects 1-7, wherein the one or more paging metrics include a respective reference signal receive power measurement for the UE for each paging occasion of the plurality of paging occasions in the collection period.

Aspect 9: The method of any of Aspects 1-8, wherein the one or more paging metrics include a maximum reference signal receive power measurement for the UE over the plurality of paging occasions in the collection period.

Aspect 10: The method of any of Aspects 1-9, wherein the one or more paging metrics include a minimum reference signal receive power measurement for the UE over the plurality of paging occasions in the collection period.

Aspect 11: The method of any of Aspects 1-10, wherein the one or more paging metrics include an average reference signal receive power measurement for the UE over the plurality of paging occasions in the collection period.

Aspect 12: The method of any of Aspects 1-11, wherein communicating with the base station to switch from the first paging carrier to the second paging carrier comprises: communicating with the base station to switch from the first paging carrier to the second paging carrier based at least in part on a determination, from the one or more paging metrics, that the first paging carrier is not efficient for the UE.

Aspect 13: The method of Aspect 12, further comprising: determining that the first paging carrier is not efficient for the UE based at least in part on a determination, from the one or more paging metrics, that a maximum repetition parameter associated with the first paging carrier is excessive.

Aspect 14: The method of any of Aspects 12-13, further comprising: determining that the first paging carrier is not efficient for the UE based at least in part on a determination, from the one or more paging metrics, that a maximum repetition parameter associated with the first paging carrier is insufficient.

Aspect 15: The method of any of Aspects 12-14, further comprising: determining that the first paging carrier is not efficient for the UE based at least in part on a determination, from the one or more paging metrics, that a page decoding failure rate for the UE on the first paging carrier satisfies a threshold.

Aspect 16: The method of any of Aspects 1-15, wherein communicating with the base station to switch from the first paging carrier to a second paging carrier comprises: transmitting, to the base station, an indication that identifies the second paging carrier; and receiving, from the base station, a confirmation to switch to the second paging carrier.

Aspect 17: The method of Aspect 16, further comprising: selecting the second paging carrier from a plurality of configured paging carriers based at least in part on a comparison of a maximum repetition criterion for the UE determined from the one or more paging metrics and a maximum repetition parameter associated with the second paging carrier.

Aspect 18: The method of any of Aspects 16-17, further comprising: identifying a set of paging carriers that satisfy a maximum repetition criterion for the UE determined from the one or more paging metrics; and randomly selecting the second paging carrier from the set of paging carriers.

Aspect 19: The method of any of Aspects 1-15, wherein communicating with the base station to switch from the first paging carrier to a second paging carrier comprises: transmitting, to the base station, an indication of a preferred value for a maximum repetition parameter determined based at least in part on the one or more paging metrics; receiving, from the base station, a confirmation to switch to a paging carrier selected from a set of paging carriers that have the preferred value for the maximum repetition parameter; and selecting the second paging carrier from the set of paging carriers that have the preferred value for the maximum repetition parameter.

Aspect 20: The method of any of Aspects 1-15, wherein communicating with the base station to switch from the first paging carrier to a second paging carrier comprises: transmitting, to the base station, an indication of a preferred value for a maximum repetition parameter determined based at least in part on the one or more paging metrics; and receiving, from the base station, an indication identifying the second paging carrier as a selected paging carrier from a set of paging carriers that have the preferred value for the maximum repetition parameter.

Aspect 21: The method of any of Aspects 1-15, wherein communicating with the base station to switch from the first paging carrier to a second paging carrier comprises: transmitting, to the base station, the one or more paging metrics; and receiving, from the base station, paging carrier information associated with switching from the first paging carrier to the second paging carrier.

Aspect 22: The method of Aspect 21, wherein communicating with the base station to switch from the first paging carrier to a second paging carrier further comprises: transmitting, to the base station, an indication that the one or more paging metrics are available; and receiving, from the base station, a request for the one or more paging metrics, wherein transmitting the one or more paging metrics to base station is based at least in part on receiving the request for the one or more paging metrics.

Aspect 23: The method of Aspect 22, wherein transmitting the indication that the one or more paging metrics are available comprises: transmitting, to the base station, the indication that the one or more paging metrics are available based at least in part on a determination, from the one or more paging metrics, that the first paging carrier is not efficient for the UE.

Aspect 24: The method of any of Aspects 21-23, wherein the paging carrier information includes a paging carrier index that identifies the second paging carrier.

Aspect 25: The method of any of Aspects 21-23, wherein the paging carrier information includes a paging carrier index that identifies a set of paging carriers, and wherein the method further comprises: selecting the second paging carrier from the set of paging carriers identified by the paging carrier index.

Aspect 26: The method of any of Aspects 21-23, wherein the paging carrier information indicates a maximum repetition parameter value, and the method further comprises: selecting the second paging carrier from one or more paging carriers that have the maximum repetition parameter value.

Aspect 27: The method of any of Aspects 21-23 or 26, wherein the paging carrier information indicates a paging cycle value, and the method further comprises: selecting the second paging carrier from one or more paging carriers that have the paging cycle value.

Aspect 28: The method of any of Aspects 21-23, wherein the paging carrier information indicates a downlink carrier frequency for the second paging carrier.

Aspect 29: The method of any of Aspects 21-23 or 28, wherein the paging carrier information indicates a power offset for the second paging carrier.

Aspect 30: The method of any of Aspects 21-23 or 28-29, wherein the paging carrier information identifies one or more paging occasions, in a frame, that are associated with the second paging carrier.

Aspect 31: A method of wireless communication performed by a base station, comprising: transmitting paging information to a user equipment (UE) on a first paging carrier over a plurality of paging occasions in a collection period; and communicating with the UE to switch a paging carrier associated with the UE from the first paging carrier to a second paging carrier based at least in part on one or more paging metrics for the first paging carrier collected by the UE over the plurality of paging occasions in the collection period.

Aspect 32: The method of Aspect 31, wherein the one or more paging metrics include a total number of paging occasions successfully decoded by the UE in the collection period.

Aspect 33: The method of any of Aspects 31-32, wherein the one or more paging metrics include a total number of paging occasion decode failures by the UE in the collection period.

Aspect 34: The method of any of Aspects 31-33, wherein the one or more paging metrics include, for each paging occasion of the plurality of paging occasions, a respective number of physical downlink control channel (PDCCH) repetitions for the UE to decode the paging occasion.

Aspect 35: The method of any of Aspects 31-34, wherein the one or more paging metrics include a minimum number of physical downlink control channel (PDCCH) repetitions for the UE to decode a paging occasion over the plurality of paging occasions in the collection period.

Aspect 36: The method of any of Aspects 31-35, wherein the one or more paging metrics include a maximum number of physical downlink control channel (PDCCH) repetitions for the UE to decode a paging occasion over the plurality of paging occasions in the collection period.

Aspect 37: The method of any of Aspects 31-36, wherein the one or more paging metrics include an average number of physical downlink control channel (PDCCH) repetitions for the UE to decode a paging occasion over the plurality of paging occasions in the collection period.

Aspect 38: The method of any of Aspects 31-37, wherein the one or more paging metrics include a respective reference signal receive power measurement for the UE for each paging occasion of the plurality of paging occasions in the collection period.

Aspect 38: The method of any of Aspects 31-38, wherein the one or more paging metrics include a maximum reference signal receive power measurement for the UE over the plurality of paging occasions in the collection period.

Aspect 40: The method of any of Aspects 31-39, wherein the one or more paging metrics include a minimum reference signal receive power measurement for the UE over the plurality of paging occasions in the collection period.

Aspect 41: The method of any of Aspects 31-40, wherein the one or more paging metrics include an average reference signal receive power measurement for the UE over the plurality of paging occasions in the collection period.

Aspect 42: The method of any of Aspects 31-41, wherein communicating with the UE to switch a paging carrier associated with the UE from the first paging carrier to a second paging carrier comprises: receiving, from the UE, an indication that identifies the second paging carrier; and transmitting, to the UE, a confirmation to switch to the second paging carrier.

Aspect 43: The method of any of Aspects 31-41, wherein communicating with the UE to switch a paging carrier associated with the UE from the first paging carrier to a second paging carrier comprises: receiving, from the UE, an indication of a preferred value for a maximum repetition parameter determined based at least in part on the one or more paging metrics; and transmitting, to the UE, a confirmation to switch to a paging carrier selected from a set of paging carriers that have the preferred value for the maximum repetition parameter.

Aspect 44: The method of any of Aspects 31-41, wherein communicating with the UE to switch a paging carrier associated with the UE from the first paging carrier to a second paging carrier comprises: receiving, from the UE, an indication of a preferred value for a maximum repetition parameter determined based at least in part on the one or more paging metrics; and transmitting, to the UE, an indication identifying the second paging carrier as a selected paging carrier from a set of paging carriers that have the preferred value for the maximum repetition parameter.

Aspect 45: The method of any of Aspects 31-41, wherein communicating with the UE to switch a paging carrier associated with the UE from the first paging carrier to a second paging carrier comprises: receiving, from the UE, the one or more paging metrics; and transmitting, to the UE, paging carrier information associated with switching from the first paging carrier to the second paging carrier.

Aspect 46: The method of Aspect 45, wherein communicating with the UE to switch a paging carrier associated with the UE from the first paging carrier to a second paging carrier further comprises: receiving, from the UE, an indication that the one or more paging metrics are available; and transmitting, to the UE, a request for the one or more paging metrics, wherein receiving the one or more paging metrics to base station is based at least in part on transmitting the request for the one or more paging metrics.

Aspect 47: The method of any of Aspects 45-46, wherein the paging carrier information includes a paging carrier index that identifies the second paging carrier.

Aspect 48: The method of any of Aspects 45-46, wherein the paging carrier information includes a paging carrier index that identifies a set of paging carriers from which the second paging carrier is to be selected by the UE.

Aspect 49: The method of any of Aspects 45-46, wherein the paging carrier information indicates a maximum repetition parameter value associated with the second paging carrier.

Aspect 50: The method of any of Aspects 45-46 or 49, wherein the paging carrier information indicates a paging cycle value associated with the second paging carrier.

Aspect 51: The method of any of Aspects 45-46, wherein the paging carrier information indicates a downlink carrier frequency for the second paging carrier.

Aspect 52: The method of any of Aspects 45-46 or 51, wherein the paging carrier information indicates a power offset for the second paging carrier.

Aspect 53: The method of any of Aspects 45-46 or 51-52, wherein the paging carrier information identifies one or more paging occasions, in a frame, that are associated with the second paging carrier.

Aspect 54: An apparatus for wireless communication at a device, comprising a processor; memory coupled with the processor; and instructions stored in the memory and executable by the processor to cause the apparatus to perform the method of one or more of Aspects 1-30.

Aspect 55: An apparatus for wireless communication at a device, comprising a processor; memory coupled with the processor; and instructions stored in the memory and executable by the processor to cause the apparatus to perform the method of one or more of Aspects 31-53.

Aspect 56: A device for wireless communication, comprising a memory and one or more processors coupled to the memory, the memory and the one or more processors configured to perform the method of one or more of Aspects 1-30.

Aspect 57: A device for wireless communication, comprising a memory and one or more processors coupled to the memory, the memory and the one or more processors configured to perform the method of one or more of Aspects 31-53.

Aspect 58: An apparatus for wireless communication, comprising at least one means for performing the method of one or more of Aspects 1-30.

Aspect 59: An apparatus for wireless communication, comprising at least one means for performing the method of one or more of Aspects 31-53.

Aspect 60: A non-transitory computer-readable medium storing code for wireless communication, the code comprising instructions executable by a processor to perform the method of one or more of Aspects 1-30.

Aspect 61: A non-transitory computer-readable medium storing code for wireless communication, the code comprising instructions executable by a processor to perform the method of one or more of Aspects 31-53.

Aspect 61: A non-transitory computer-readable medium storing a set of instructions for wireless communication, the set of instructions comprising one or more instructions that, when executed by one or more processors of a device, cause the device to perform the method of one or more of Aspects 1-30.

Aspect 63: A non-transitory computer-readable medium storing a set of instructions for wireless communication, the set of instructions comprising one or more instructions that, when executed by one or more processors of a device, cause the device to perform the method of one or more of Aspects 31-53.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory, the one or more processors configured to:
collect one or more paging metrics for a first paging carrier over a plurality of paging occasions in a collection period; and
communicate with a base station to switch from the first paging carrier to a second paging carrier based at least in part on the one or more paging metrics for the first paging carrier.

2. The UE of claim 1, wherein the one or more paging metrics include at least one of:
a total number of paging occasions successfully decoded by the UE in the collection period,
a total number of paging occasion decode failures by the UE in the collection period,
for each paging occasion of the plurality of paging occasions, a respective number of physical downlink control channel (PDCCH) repetitions for the UE to decode the paging occasion,
a minimum number of PDCCH repetitions for the UE to decode a paging occasion over the plurality of paging occasions in the collection period,
a maximum number of PDCCH repetitions for the UE to decode a paging occasion over the plurality of paging occasions in the collection period,
an average number of PDCCH repetitions for the UE to decode a paging occasion over the plurality of paging occasions in the collection period,
a respective reference signal receive power measurement for the UE for each paging occasion of the plurality of paging occasions in the collection period, or
a maximum reference signal receive power measurement for the UE over the plurality of paging occasions in the collection period.

3. The UE of claim 1, wherein the one or more paging metrics include a minimum reference signal receive power measurement for the UE over the plurality of paging occasions in the collection period.

4. The UE of claim 1, wherein the one or more paging metrics include an average reference signal receive power measurement for the UE over the plurality of paging occasions in the collection period.

5. The UE of claim 1, wherein the one or more processors, to communicate with the base station to switch from the first paging carrier to the second paging carrier, are configured to:
communicate with the base station to switch from the first paging cater to the second paging carrier based at least in part on a determination, from the one or more paging metrics, that the first paging cater is not efficient for the UE.

6. The UE of claim 5, wherein the one or more processors are further configured to determine that the first paging cater is not efficient for the UE based at least in part on at least one of:
a determination, from the one or more paging metrics, that a maximum repetition parameter associated with the first paging carrier is excessive,
a determination, from the one or more paging metrics, that the maximum repetition parameter associated with the first paging carrier is insufficient, or
a determination, from the one or more paging metrics, that a page decoding failure rate for the UE on the first paging carrier satisfies a threshold.

7. The UE of claim 1, wherein the one or more processors, to communicate with the base station to switch from the first paging carrier to a second paging carrier, are configured to:
select the second paging carrier from a plurality of configured paging carriers based at least in part on a comparison of a maximum repetition criterion for the UE determined from the one or more paging metrics and a maximum repetition parameter associated with the second paging cater;
transmit, to the base station, an indication that identifies the second paging cater; and
receive, from the base station, a confirmation to switch to the second paging carrier.

8. The UE of claim 1, wherein the one or more processors, to communicate with the base station to switch from the first paging carrier to a second paging carrier, are configured to:
transmit, to the base station, an indication of a preferred value for a maximum repetition parameter determined based at least in part on the one or more paging metrics;
receive, from the base station, a confirmation to switch to a paging cater selected from a set of paging carriers that have the preferred value for the maximum repetition parameter; and
select the second paging carrier from the set of paging carriers that have the preferred value for the maximum repetition parameter.

9. The UE of claim 1, wherein the one or more processors, to communicate with the base station to switch from the first paging carrier to a second paging carrier, are configured to:
transmit, to the base station, an indication of a preferred value for a maximum repetition parameter determined based at least in part on the one or more paging metrics; and
receive, from the base station, an indication identifying the second paging carrier as a selected paging carrier from a set of paging carriers that have the preferred value for the maximum repetition parameter.

10. The UE of claim 1, wherein the one or more processors, when communicating with the base station to switch from the first paging carrier to a second paging carrier, are configured to:
transmit, to the base station, the one or more paging metrics; and
receive, from the base station, paging carrier information associated with switching from the first paging carrier to the second paging carrier.

11. The UE of claim 10, wherein the one or more processors, to communicate with the base station to switch from the first paging carrier to a second paging carrier, are further configured to:
transmit, to the base station, an indication that the one or more paging metrics are available; and
receive, from the base station, a request for the one or more paging metrics, wherein transmitting the one or more paging metrics to base station is based at least in part on receiving the request for the one or more paging metrics.

12. The UE of claim 11, wherein the one or more processors, to transmit the indication that the one or more paging metrics are available, are further configured to:
transmit, to the base station, the indication that the one or more paging metrics are available based at least in part on a determination, from the one or more paging metrics, that the first paging carrier is not efficient for the UE.

13. The UE of claim 10, wherein the paging carrier information includes a paging carrier index that identifies the second paging carrier.

14. The UE of claim 10, wherein the paging carrier information includes a paging carrier index that identifies a set of paging carriers, and wherein the one or more processors are further configured to:
select the second paging carrier from the set of paging carriers identified by the paging carrier index.

15. The UE of claim 10, wherein the paging carrier information indicates a maximum repetition parameter value or a paging cycle value, and the one or more processors are further configured to:
select the second paging carrier from one or more paging carriers that have the maximum repetition parameter value or the paging cycle value.

16. The UE of claim 10, wherein the paging carrier information indicates at least one of a downlink carrier frequency for the second paging carrier, a power offset for the second paging carrier, or one or more paging occasions, in a frame, that are associated with the second paging carrier.

17. A base station for wireless communication, comprising:
a memory; and
one or more processors coupled to the memory, the one or more processors configured to:
transmit paging information to a user equipment (UE) on a first paging carrier over a plurality of paging occasions in a collection period; and
communicate with the UE to switch a paging carrier associated with the UE from the first paging carrier to a second paging carrier based at least in part on one or more paging metrics for the first paging carrier collected by the UE over the plurality of paging occasions in the collection period.

18. The base station of claim 17, wherein the one or more paging metrics include at least one of:
a minimum reference signal receive power measurement for the UE over the plurality of paging occasions in the collection period, or
an average reference signal receive power measurement for the UE over the plurality of paging occasions in the collection period.

19. The base station of claim 17, wherein the one or more processors, to communicate with the UE to switch a paging carrier associated with the UE from the first paging carrier to a second paging carrier, are configured to:
receive, from the UE, the one or more paging metrics; and
transmit, to the UE, paging carrier information associated with switching from the first paging carrier to the second paging carrier.

20. The base station of claim 19, wherein the paging carrier information includes a paging carrier index that identifies the second paging carrier or identifies a set of paging carriers from which the second paging carrier is to be selected by the UE.

21. A method of wireless communication performed by a user equipment (UE), comprising:
collecting one or more paging metrics for a first paging carrier over a plurality of paging occasions in a collection period; and
communicating with a base station to switch from the first paging carrier to a second paging carrier based at least in part on the one or more paging metrics for the first paging carrier.

22. The method of claim 21, wherein the one or more paging metrics include a minimum reference signal receive power measurement for the UE over the plurality of paging occasions in the collection period.

23. The method of claim 21, wherein the one or more paging metrics include an average reference signal receive power measurement for the UE over the plurality of paging occasions in the collection period.

24. The method of claim 21, wherein communicating with the base station to switch from the first paging carrier to a second paging carrier comprises:
transmitting, to the base station, the one or more paging metrics; and
receiving, from the base station, paging carrier information associated with switching from the first paging carrier to the second paging carrier.

25. The method of claim 24, wherein the paging carrier information includes a paging carrier index that identifies the second paging carrier.

26. The method of claim 24, wherein the paging carrier information includes a paging carrier index that identifies a set of paging carriers, and wherein the method further comprises:
selecting the second paging carrier from the set of paging carriers identified by the paging carrier index.

27. A method of wireless communication performed by a base station, comprising:
transmitting paging information to a user equipment (UE) on a first paging carrier over a plurality of paging occasions in a collection period; and
communicating with the UE to switch a paging carrier associated with the UE from the first paging carrier to a second paging carrier based at least in part on one or more paging metrics for the first paging carrier collected by the UE over the plurality of paging occasions in the collection period.

28. The method of claim 27, wherein the one or more paging metrics include at least one of:
a minimum reference signal receive power measurement for the UE over the plurality of paging occasions in the collection period, or
an average reference signal receive power measurement for the UE over the plurality of paging occasions in the collection period.

29. The method of claim 27, wherein communicating with the UE to switch a paging carrier associated with the UE from the first paging carrier to a second paging carrier comprises:
receiving, from the UE, the one or more paging metrics; and
transmitting, to the UE, paging carrier information associated with switching from the first paging carrier to the second paging carrier.

30. The method of claim 29, wherein the paging carrier information includes a paging carrier index that identifies the second paging carrier or identifies a set of paging carriers from which the second paging carrier is to be selected by the UE.
